(19) United States
(12) Patent Application Publication
(10) Pub. No.: US 2006/0272405 A1
(43) Pub. Date: Dec. 7, 2006

(54) Casing for in-tank hall effect sensor used for fuel level sensing

(76) Inventors: Lajos Feher, Szekesfehervar (HU); Zoltan Z. Horvath, Szekesfehervar (HU); Zsolt Kariko, Szekesfehervar (HU); Taylor Riegel, Berkley, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/147,087

(22) Filed: Jun. 7, 2005

(51) Int. Cl. G01F 23/52

(52) U.S. Cl. 73/313

(57) ABSTRACT

The invention relates to a non-contact sensor assembly having a casing with a cavity, a magnetic field sensor disposed within the cavity and a cap coupled to close the cavity. The cap has one or more openings through which pins, extending from the sensor or its associated circuit board extend. A sealant is located between the pin and the opening in the cap that hermetically seals the opening and the cavity. The non-contact sensor assembly may be used with a fuel level sensing device.

### BACKGROUND

1. Field of the Invention

The present invention generally relates to non-contact sensors and more particularly to non-contact sensors located within the fuel tank of a vehicle.

2. Description of the Known Technology

Vehicles fuel tanks have fuel level sensing devices for detecting the amount of fuel contained within. Typically, the fuel level sensing device includes a rotatable arm having a floatation device connected to the free end of the arm. As the level of fuel rises and falls, the floatation device causes the arm to rotate about its pivot point correspondingly. The fuel level sensing devices monitors the angular position of its arm and transmits this information to a gauge located within the passenger compartment of the vehicle.

In the past, several types of sensors have been used to detect the movement of the arm. The most common sensor is either a rheostat or a potentiometer having a sliding contact spring that presses one or more contact elements against a ceramic-based thick film resistor card. As the arm rotates, the contact element or elements are caused to slide along the surface of the resistor card contacting different printed conductors. When the contact element or elements physically touch successive printed conductors, an electrical circuit is formed having a resistance indicative of the specific fuel level. In this manner, as the arm sweeps through all of its angular positions between full and empty, a varying electrical resistance signal is generated that corresponds to any particular fuel level. Because the contact element or elements must make physical sliding electrical contact with the surface of the thick film card, friction is created between the contact element or elements and the card surface, causing wear and thus limiting the operating life of this type of sensor. Additionally, because the sliding electrical contact surfaces are exposed to the fuel and any fuel-borne contaminants, they can undergo chemical attack and provide reduced performance as a result.

One solution to these problems is to sense the float arm position using a non-contacting methodology, such as a Hall Effect sensor. A Hall Effect sensor will output an electrical signal based upon the magnetic field detected. In practice, a magnet is configured to move with the movement of the arm and a Hall Effect sensor is located in a fixed position nearby. As the arm and magnet move, the magnetic field detected by the Hall Effect sensor changes. The changes in the magnetic field received by the Hall Effect sensor are converted to an output that is indicative of the float arm position and hence the amount of fuel contained within the tank. This output will then be transmitted to the gauge.

However, there are some drawbacks to using non-contact sensors, such as Hall Effect sensors. Because the fuel level sensing device is located within the fuel tank, the non-contact sensor is immersed in fuel. Traditionally, the non-contact sensor is contained within a plastic casing comprised of epoxy or other electrically insulating materials and may even be overcoated or “potted” by additional protective agents. In spite of this protection, the fuel may eventually reach the sensor either though infiltration or permeation. With infiltration, the protective coverings or overcoverings do not adhere sufficiently to the metal leads connected to the non-contact sensor. Fuel and any fuel-borne corrosive contaminants will eventually travel along the leads by capillary action to the sensor. With permeation, protective coverings or overcoverings allow fuel and any fuel-borne corrosive contaminants to diffuse through them, eventually reaching the non-contact sensor. When fuel and any fuel-borne reach the non-contact sensor through either infiltration or permeation, the non-contact sensor will fail.

Therefore, there exists a need to provide protection for a non-contact sensor assembly that can withstand the harsh environment within the fuel tank of a vehicle.

### BRIEF SUMMARY

In overcoming the drawbacks and limitations of the known technology, a non-contact sensor assembly and a fuel level sensing device is disclosed. The non-contact sensor assembly includes a casing having an opening and a cavity defined within. Within the cavity is a magnetic sensing device having at least one pin protruding through the opening of the casing. A cap is attached to the opening of the casing such that the pin protrudes through an opening in the cap. To form a hermetic seal between the pin and the opening in the cap, a sealant is located between.

The casing and/or the cap may be constructed of a non-ferromagnetic material, preferably austenitic stainless steel. The magnetic sensing device may further include a printed circuit board associated with the sensor. Generally, the sensor is either a Hall Effect sensor or a giant magneto resistive sensor.

The non-contact sensor assembly may be used with a fuel level sensing device, such as the construction described above having a rotatable central shaft coupled to a float and a magnet fixed to the rotatable central shaft, such that when the central shaft rotates, as induced by the float, the magnet rotates as well.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a cross-sectional view of a non-contact sensor assembly embodying the principles of the present invention;

FIG. 2 is a top view of the non-contact sensor assembly embodying the principles of the present invention;

FIG. 3 is a bottom view of the non-contact sensor assembly embodying the principles of the present invention; and

FIG. 4 is a view of a fuel level sensing device embodying the principles of the present invention.

### DETAILED DESCRIPTION

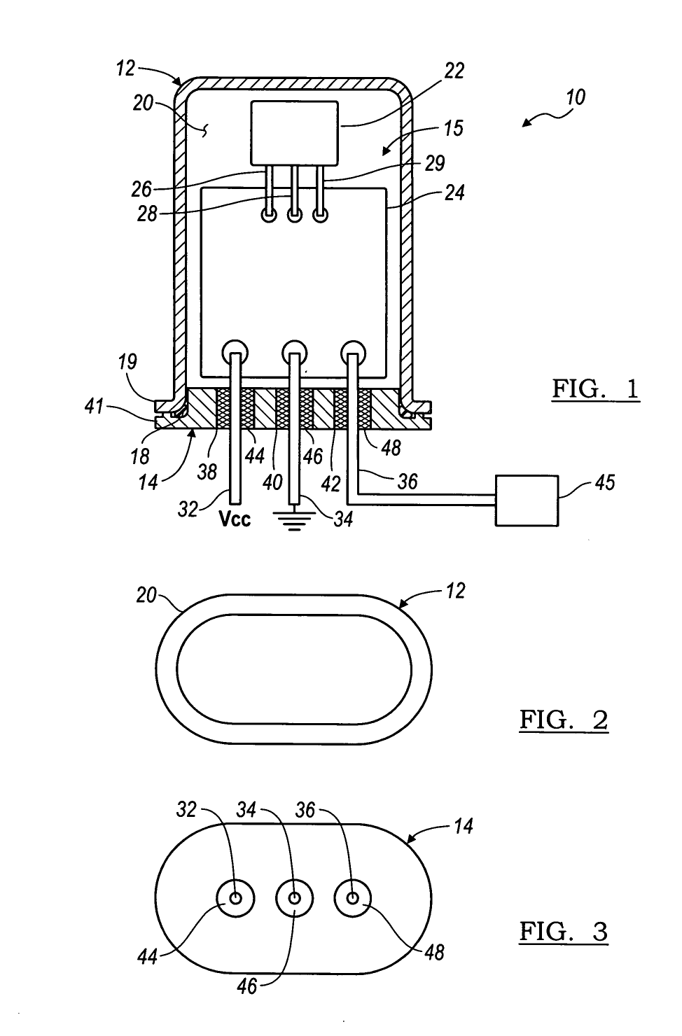

Referring now to FIGS. 1, 2 and 3, a non-contact sensor assembly 10 embodying the principles of the present invention is shown therein. The non-contact sensor assembly generally includes a casing 12, and cap 14 and a magnetic sensing device 15.

The casing 12 defines a cavity 20 having an opening 18 with a lip 19 extending therearound. While the casing may be made of any non-ferromagnetic material, it is preferably constructed of a material such as austenitic stainless steel.

Disposed within the cavity 20 is the magnetic sensing device 15. Generally, the magnetic sensing device 15 includes a sensor 22 and a printed circuit board 24. The sensor 22 is preferably a Hall Effect sensor but may be a giant magneto resistive sensor or similar device.

The sensor 22 and the printed circuit board 24 are in electrical communication with each other via one or more communication lines 26, 28, 29. Connected to the printed circuit board 24 are a series of pins, which in the preferred embodiment include a power pin 32, a ground pin 34 and a signal pin 36. The power pin 32 and the ground pin 34 provide the necessary voltage and grounding signal required for the magnetic sensing device 15 to operate. The signal pin 36 provides a communication conduit for the output of the sensor 22 to a gauge 45 or other device displaying the fuel level. An alternate configuration uses only two pins and these two pins provide both electrical power for the magnetic field sensor and a means of conveying the output signal to the gauge, such as a pulse-code modulated signal impressed on top of the direct current supply voltage.

Generally covering the opening 18 of the casing 12 is a cap 14. The cap 14 includes a lip 41 for engaging the lip 19 of the casing 12. This lip 41 of the cap 14 is connected the lip 19 of the casing 12 via a welding process to form a fluid tight seal. Alternatively, the lip 41 of the cap 14 may be connected to the lip 19 of the casing 12 through the use of an adhesive-sealant.

Also provided in the cap 14 is one or more openings through which the pins 32, 34, 36 protrude. Preferably, the number of openings correspond to the number of pins, and, accordingly, in the illustrated embodiment there are three openings 38, 40, 42. Non-conductive insulators 44, 46, 48 are placed within the openings 38, 40, 42 to form a hermetic seal between the pins 32, 34, 36 and the openings 38, 40, 42. The non-conductive insulators 44, 46, 48 are preferably made of glass, but may be made of any non-conductive material suitable for this purpose.

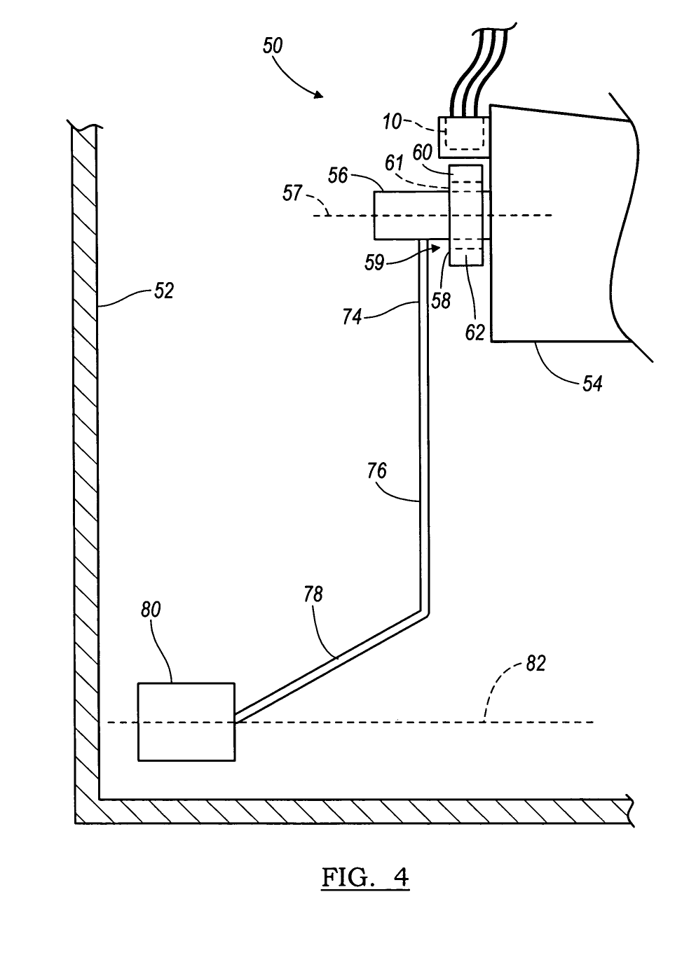

Now referring to FIG. 4, a fuel level sensing device 50 located within a fuel tank 52 of a vehicle is shown. The fuel level sensing device 50 includes a central shaft 56 supported by a support 54 for rotation around an axis 57. An arm 76 is connected to the rotatable central shaft 56 at a first end 74. The arm 76 extends generally radially away from the central shaft 56, and at a second end 78, connects to a flotation device 80. The flotation device 80 is of a material that is buoyant in fuel and is shown floating at the surface of the fuel located within the fuel tank 52, as indicated by the dashed line 82.

Rigidly connected so as to rotate with the central shaft 56 is a magnet assembly 59. The magnet assembly 59 includes a hub 61, preferably made of a polymer. The hub 61 is connected to a magnet 58, shown as a ring of ferromagnetic material, and the central shaft 56 by frictional engagement. The magnet 58 is configured to extend at least partly around the central shaft so that as the central shaft 56 rotates, poles 60, 62 of the magnet 58 will also be caused to rotate around the axis 57.

Fixedly mounted in proximity to the magnet assembly 59 is the magnetic sensing device 10. As such, the device 10 may be commonly supported by the support 54.

When the fuel level 82 of the fuel tank 52 changes, the flotation device 80 changes position, thus moving the arm 76 and in turn rotating the central shaft 56 and the poles 60, 62 of the magnet 58 about the axis 57. As the poles 60, 62 rotate around the axis 57, the magnetic field about the magnetic sensing device 10 changes, altering the signal output from the device 10, which corresponds with the amount of fuel 82 located within the fuel tank 52.

The foregoing description of the embodiment of the invention has been presented for purposes of illustration and description. It is not intended to be exhaustive or to limit the invention to the precise embodiment disclosed. Numerous modifications or variations are possible in light of the above teaching. The embodiment discussed was chosen and described to provide the best illustration of the principles of the invention in its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A non-contact sensor assembly comprising:
a casing having an opening and a cavity defined therein;
a magnetic sensing device located within the cavity, the magnetic sensing device having at least one pin protruding out of the opening of the casing;
a cap fixedly attached to the opening of the casing, the cap having at least one opening and the at least one pin protruding through the at least one opening of the cap; and
a sealant located between the at least one pin and the at least one opening of the cap, whereby the sealant defines a hermetic seal between the at least one pin and the at least one opening of the cap.

2. The assembly of claim 1, wherein the casing is constructed of a non-ferromagnetic material.

3. The assembly of claim 2, wherein the non-ferromagnetic material is austenitic stainless steel.

4. The assembly of claim 1, wherein the cap is constructed of a non-ferromagnetic material.

5. The assembly of claim 4, wherein the non-ferromagnetic material is austenitic stainless steel.

6. The system of claim 1, wherein the magnetic sensor device further comprises a sensor coupled to a printed circuit board.

7. The system of claim 6, wherein the sensor is a Hall Effect sensor.

8. The system of claim 6, wherein the sensor is a giant magneto resistive sensor.

9. The system of claim 1, wherein the sealant is a non-conductive material.

10. The system of claim 9, wherein the non-conductive material is glass.

11. A fuel level sensing device comprising:
a central shaft, rotatably supported by a support member for rotation about an axis;
a magnet assembly coupled to the central shaft for rotation together with the central shaft;
a non-contact sensor assembly located in proximity to the magnet and the magnetic field produced by the magnet;
an arm having a first end connected to the rotatable central shaft; and
a flotation device connected to a second end of the arm, whereby movement of the flotation device as the fuel level changes causes rotation the central shaft via the arm.

12. The device of claim 11, wherein the magnet assembly further comprises a ring of magnetized ferromagnetic material surrounding a polymer hub, the polymer hub being coupled to the central shaft.

13. The device of claim 11, wherein the non-contact sensor assembly further comprises:
a casing having an opening and a cavity defined therein;
a magnetic sensing device located within the cavity, the magnetic sensing device having at least one pin protruding out of the opening of the casing;
a cap fixedly attached to the opening of the casing, the cap having at least one opening and the at least one pin protruding through the opening of the cap; and
a sealant located between the at least one pin and the at least one opening of the cap, whereby the sealant forms a hermetic seal between the at least one pin and the at least one opening of the cap.

14. The device of claim 13, wherein the casing is constructed of a non-ferromagnetic material.

15. The device of claim 14, wherein the non-ferromagnetic material is austenitic stainless steel.

16. The device of claim 13, wherein the cap is constructed of a non-ferromagnetic material.

17. The device of claim 16, wherein the non-ferromagnetic material is austenitic stainless steel.

18. The device of claim 13, wherein the magnetic sensing device further comprises a sensor coupled to a printed circuit board.

19. The device of claim 18, wherein the sensor is a Hall Effect sensor.

20. The device of claim 18, wherein the sensor is a giant magneto resistive sensor.

21. The device of claim 13, wherein the sealant is composed of a non-conductive material.

22. The device of claim 21, wherein the non-conductive material is glass.
